(19) United States
(12) Patent Application Publication
(10) Pub. No.: US 2010/0269104 A1
(43) Pub. Date: Oct. 21, 2010

(54) System and Methods for Generic Data Marshalling without Object Modification

(75) Inventor: Joshua Woods, Raleigh, NC (US)

Correspondence Address: CAHN & SAMUELS, LLP, 1100 17th STREET, NW, SUITE 401, WASHINGTON, DC, 20036, US

(73) Assignee: INTERNATIONAL BUSINESS MACHINES CORPORATION, Armonk, NY (US)

(21) Appl. No.: 12/424,838

(22) Filed: Apr. 16, 2009

(51) Int. Cl. G06F 9/45

(52) U.S. Cl. 717/147

(57) ABSTRACT

A method for generic marshalling without object modification includes making a service request for at least one object by inputting data into a computer system; constructing at least one marshalling request from the service request to marshal the at least one object; selecting a marshaller that supports an output format for the data; an abstract marshaller calling at least one strategy provider based on the at least one marshalling request and the selected marshaller; and the at least one strategy provider calling at least one strategy. The at least one strategy defines a translation that converts values from the at least one object into a generic format recognized by the abstract marshaller so the values are translated into the specific output format supported by the selected marshaller.

### I. FIELD OF THE INVENTION

This invention relates to a system and methods for generic data marshaling without object modification.

### II. BACKGROUND OF THE INVENTION

The need to support data manipulation and transformation, for example via web services, presents two major problems. First, request and response formats change over time. Second, in many cases, services must be retrofitted to an existing application, which often involves changing the existing (and often vetted) code or creating an entirely new code path.

To aid software developers in creating services for various formats (e.g., SOAP, REST), many marshalling packages exist to convert data objects to binary or textual data. Marshalling comprises taking a data object and making it conform to a data representation of how to store it which can be communicated over a protocol (e.g., externally via TCP/IP or internally in a machine over a bus). In a specific embodiment, marshaling is an operation that is used when transmitting an object between address spaces. Marshaling takes an object and places enough information (i.e., the marshaled form of the object) in a communications buffer so that an essentially identical object can be unmarshaled from this buffer in another address space. Unmarshaling is an operation that is used when receiving an object from another address space. Unmarshaling creates or fabricates an object in the new address space by using the marshaled form (e.g., a string of bits) of the transmitted object.

However, most marshalling packages output only one single format, which means two or more marshalling packages are needed to support different output formats. Also, most marshalling packages rely solely on generated code and XML bindings, which often require a 1-to-1 relationship between a plain object and an output format or the creation of an entirely new object to serve this purpose. Thus, when introducing services to an existing system or application, a lot of re-architecting is required (which requires re-vetting working code) or a maintenance nightmare is created by having a separate service-only data model.

The present invention provides a solution to these problems. First, the present invention provides an intermediary between objects and their resultant output formats which processes data in an agnostic format, thereby allowing different marshallers to be plugged in dynamically. Second, the present invention allows for the creation of multiple marshalling strategies for a single object, which allows for changes to the verbosity or scope of an object without changing the underlying data model.

### III. SUMMARY OF THE INVENTION

A method for generic marshalling without object modification is provided. A service request is made for at least one object by inputting data into a computer system. At least one marshalling request is constructed from the service request to marshal the at least one object. A marshaller is selected that supports an output format for data requested by the at least one marshalling request. An abstract marshaller calls at least one strategy provider based on the at least one marshalling request and the selected marshaller. The at least one strategy provider calls at least one strategy. The at least one strategy defines a translation that converts values from the at least one object into a generic format recognized by the abstract marshaller so the values are translated into the specific output format supported by the selected marshaller.

According to another aspect of the present invention, a method for generic marshalling without object modification is provided. A service request is made for at least one object by inputting data into a computer system. At least one marshalling request is constructed from the service request to marshal the at least one object. A marshaller is selected that supports an output format for the data. An abstract marshaller calls at least one strategy provider when non-defined data is encountered in the at least one marshalling request. The at least one strategy provider calls at least one strategy. If the data requested in the at least one marshalling request is simple, the abstract marshaller invokes the at least on strategy to obtain values for the data from the at least one object. If the data requested in the at least one marshalling request is complex, the abstract marshaller recurses the complex data and calls the at least one strategy provider. The abstract marshaller calls a grammar method to request the obtained values be in a generic format that can be read by the selected marshaller. The selected marshaller implements the grammar method and outputs the obtained values in the output format.

According to another aspect of the present invention, an apparatus for generic marshalling without object modification is provided. The apparatus comprises an agent for generic marshalling of an object and at least one client for processing of data from the at least one object. The at least one client comprises an abstract marshaller to provide generic resolution support for at least one marshaller and a strategy provider to produce or call at least one strategy.

According to another aspect of the invention, a computer program product is provided comprising a computer useable medium having a computer readable program. When executed on a computer, the computer readable program causes the computer to make a service request for at least one object by inputting data into a computer system; construct at least one marshalling request from the service request to marshal the at least one object; select a marshaller that supports an output format for data from the at least one object; an abstract marshaller calls at least one strategy provider based on the at least one marshalling request and the selected marshaller; and at least one strategy provider calls at least one strategy. The at least one strategy defines a translation that converts data from the at least one object into a generic format recognized by the abstract marshaller so it can be converted in to the specific output format supported by the selected marshaller.

As used herein “substantially”, “relatively”, “generally”, “about”, and “approximately” are relative modifiers intended to indicate permissible variation from the characteristic so modified. They are not intended to be limited to the absolute value or characteristic which it modifies but rather approaching or approximating such a physical or functional characteristic.

In the detailed description, references to “one embodiment”, “an embodiment”, or “in embodiments” mean that the feature being referred to is included in at least one embodiment of the invention. Moreover, separate references to “one embodiment”, “an embodiment”, or “in embodiments” do not necessarily refer to the same embodiment; however, neither are such embodiments mutually exclusive, unless so stated, and except as will be readily apparent to those skilled in the art. Thus, the invention can include any variety of combinations and/or integrations of the embodiments described herein.

Given the following enabling description of the drawings, the system and methods should become evident to a person of ordinary skill in the art.

### IV. BRIEF DESCRIPTION OF THE DRAWINGS

FIG. 1 illustrates a process flow block diagram according to an embodiment of the present invention.

FIG. 2 illustrates a flowchart for a method according to an embodiment of the present invention.

FIG. 3 illustrates a block diagram of a system according to an embodiment of the invention.

FIG. 4 illustrates is a data processing system according to an embodiment of the present invention.

### V. DETAILED DESCRIPTION OF THE DRAWINGS

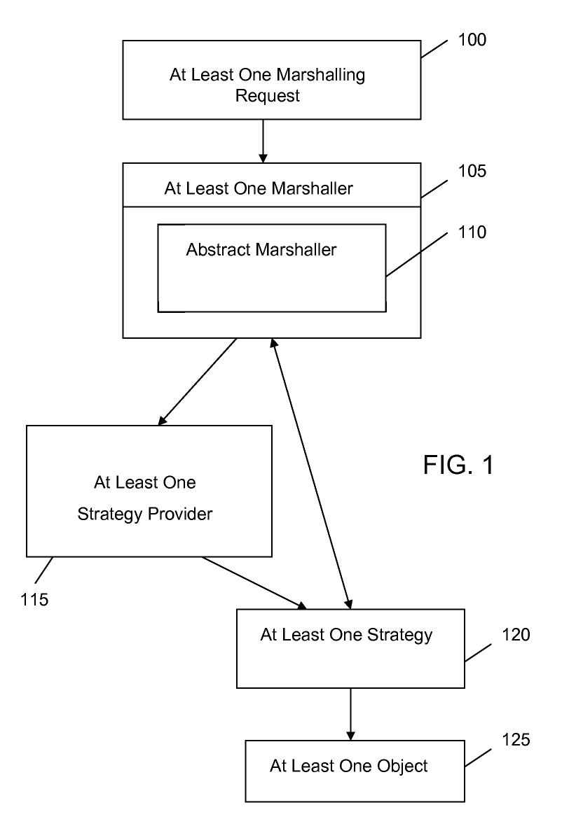

FIGS. 1-4 illustrate a system and methods for generic data marshaling without object modification. In embodiments, an object may comprise data in the form of a collection of at least one of values, properties, or methods stored in memory. According to the present invention, the object is not modified during the marshalling process. The underlying application or code does not need to be changed. No new class has to be created.

As illustrated in the process flow block diagram of FIG. 1, the present invention comprises at least one marshalling request 100, at least one marshaller 105, an abstract marshaller 110, at least one strategy provider 115, and at least one strategy 120. In embodiments, the abstract marshaller 110 may comprise a core component from which the at least one marshaller 105 extends. The combination of the abstract marshaller 110 and at least one strategy provider 115 comprises an intermediary between at least one object 125 and its resultant output format. The intermediary processes data in an agnostic or generic manner, thereby allowing different marshallers (e.g., JavaScript Object Notation or JSON; XML) to be dynamically plugged into a system. This configuration also allows augmentation of existing applications for services without the need to alter working logic.

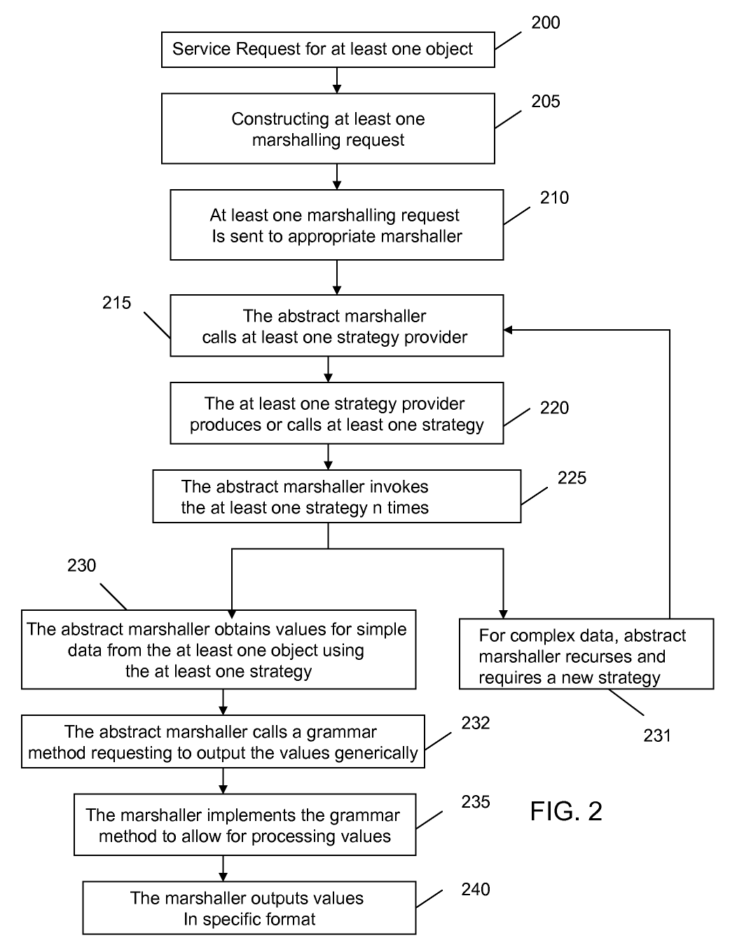

FIG. 2 illustrates a flowchart of a method according to an embodiment of the present invention.

A user makes a service request for at least one object, for example, by inputting data in a web browser, 200. The data in the service request may comprise at least one of an object name, output format for the at least one object, or scope of the at least one object (i.e., verbosity). At least one marshalling request is constructed from the service request in order to marshal the at least one object, 205. In embodiments, the at least one marshalling request may be constructed according to a predetermined fixed rule for the data in the service request.

The at least one marshalling request is sent to the appropriate marshaller, 210. The selected marshaller comprises the available output format for data requested by the at least one marshalling request. Thus, for example, a JSON marshaller provides output in JSON format; whereas, an XML marshaller provides output in XML format. In embodiments, there may be a single marshaller or at least two marshallers. However, there may be a plurality of marshallers.

Based on the at least one marshalling request and the selected marshaller, the abstract marshaller calls at least one strategy provider, 215. The abstract marshaller may define different data types. Simple or concrete data comprises at least one of a string, number, or property. Compound data comprises at least one of a list, set, or hash. Complex data comprises a collection of properties. In embodiments, the abstract marshaller calls the least one strategy provider when non-defined or non-built-in data is encountered in the at least one marshalling request. For example, the abstract marshaller may define simple data and call the at least one strategy provider when complex data is encountered. By relying on the at least one strategy provider and by supporting defined data types, the abstract marshaller provides generic resolution support for the selected marshaller as discussed below.

The at least one strategy provider produces or calls at least one strategy, 220, for example, at runtime of the at least one marshalling request. The at least one strategy is specified for data types that are not defined in the abstract marshaller. In embodiments, the at least one strategy is specified for at least one of simple or compound data, thereby defining output values (e.g., output strings, numbers) for such data from the at least one object. The at least one strategy comprises an interface that converts values from the at least one object into a generic format recognized by the abstract marshaller. Thus, the at least one strategy provides a translation between the data requested in the at least one marshalling request and the resultant output format for the marshalled object.

The at least one strategy may comprise a plurality of strategies for a single object, for example, based on different verbosity levels for the data in the at least one marshalling request. Thus, the at least one strategy may comprise a plurality of strategies arranged in a hierarchical manner. Alternatively, a plurality of strategies may be arranged in an arbitrary manner. For example, an input parameter called “department” may correspond to either an “accounting” or “IT” department. The representation changes because, while the numerical data may not be important to IT, another data field may be needed. Accordingly, there is not a hierarchy between the “accounting” or “IT” department.

In embodiments, the at least one marshalling request may comprise static data type-to-strategy mapping which may be used by the at least one strategy provider to look up a particular strategy. For example, for simple data a particular strategy may be identified. For a complex data, a different strategy may be identified. The strategy used to marshal the at least one object may change based on the verbosity or scope of the data in the at least one marshalling request.

In other embodiments, data type-to-strategy mapping may be built dynamically at runtime based on a rule set. For example, all “beans” (using a Java example) in a name space may be fully marshalled to include all dependent beans (all data property/value pairs), but in another name space only top-level items may be included and the child types may be treated as a reference id. Thus, for example, for a “Car” object, there may be a simple core make/model data set which comprises strings, but it also has an engine object which comprises complex data. According to the rule set, in one name space the data-to-strategy mapping would dereference the engine. In another name space, the data-to-strategy mapping may return an engineId. The dynamic data type-to-strategy mapping allows augmentation or shadowing of the core data type.

In embodiments, the at least one strategy does not need to be embedded in an existing application, but can be built at run time via introspection. For example, the at least one strategy may extend data (e.g., a bean) automatically by making a data source query.

Once the at least one strategy is called and returned by the at least one strategy provider, the abstract marshaller invokes the at least one strategy, 225. The at least one strategy provider may call the at least one strategy n number of times, where n is an integer. Depending on the data in the at least one marshalling request, the marshalling process may branch as follows.

The abstract marshaller obtains values for simple data from the at least one object using the strategy, 230. For example, if the object is “Car”, the abstract marshaller may return values for simple data (e.g., make, model) that are defined in a Java class. For compound data (e.g., list or set), the abstract marshaller has semantics to start the list, iterate through the list, and end the list.

If the data specified in the at least one marshalling request is complex, the abstract marshaller recurses the data (separates or maps the data into simple or compound data), 231, and calls the at least one strategy provider. The at least one strategy provider produces or calls at least one new strategy based on the recursion. For example, if the object is Quarterly Report, there may be some data (e.g., date) that are defined in a Java class, but there may be other data properties that require querying a database or computation in the at least one strategy (augmentation without changing the core code) to return the desired values.

The abstract marshaller calls a grammar method requesting that the values be output in a generic format that can be read by the selected marshaller 232. In embodiments, the abstract marshaller defines the grammar methods or grammar handlers. The selected marshaller implements the grammar methods in the abstract marshaller to allow for the processing of the values 235 and outputting the values via a specific formatting logic 240. If the at least one object comprises a list or graph of objects, the abstract marshaller may iterate or work through the multiple objects and recurse as needed.

The following is a non-limiting example of a method of the present invention presented for illustrative purposes only:

### EXAMPLE

### A. Client

A user makes a REST-ful service request over HTTP via a web service. Based on the request, a client provides data for an object (Person), output format, and verbosity.

### B. Server

The server is a J2EE container. A servlet reads the data for the object and constructs an implementation of the object Person (PersonImpl). The implementation comprises at least one of getters, setters, properties, helper methods, or the like. The object need not be modified or interfaced in any way to be used.

### C. Marshallers

There are two Marshallers: (1) a JSON marshaller, which provides output in JSON format; and (2) an XML marshaller, which provides output in XML format. The core Abstract Marshaller functions to process PersonImpl in a generic format.

### D. Strategy Providers

There are two Strategy Providers. A Core Strategy Provider selects specific strategies for PersonImpl. A Bean Strategy Provider introspects a bean and, for every bean property, returns the resultant value. The Bean Strategy Provider can provide strategies on demand.

### E. Strategies

There are two Strategies. A Person Simple strategy returns basic data (e.g., name, DOB, address) by querying fields via getters and properties in Person. The strategy maps output values or properties for the data to internal actions. For example, the property “name” maps to PersonImpl.getName( ). The strategy could also map to a custom method in the strategy itself.

A Person Complex strategy extends the Person Simple strategy to include extra fields (e.g., income, position, employer) that the strategy provides by making a data source query. For example, employer is a generic bean that is mapped to an “employer” field and is a complex data type in the output. The value is provided by the strategy using a custom data access code, but is not known by PersonImpl. The Bean Strategy Provider introspects the bean Employer and returns the value, thereby producing a strategy for Employer.

### F. Marshalling Request

A Marshalling Request comprising PersonImpl is constructed from the data in the service request. The Marshalling Request also identifies the Core Strategy Provider, which internally leverages the Bean Strategy Provider. Data type-to-strategy mapping varies based on the verbosity parameter. If “simple” is selected for PersonImpl, then the Person Simple strategy is selected. Otherwise, the “complex” Person Complex strategy is selected.

### G. Flow

Based on the output format identified in the service request, the Marshalling Request is sent to either the JSON marshaller or the XML marshaller.

The Abstract Marshaller examines a current object in an object graph, which starts with PersonImpl. Based on the verbosity, the Abstract Marshaller passes the Person Complex type-to-strategy mapping to the Core Strategy Provider.

The Core Strategy Provider calls the Person Complex strategy. The Abstract Marshaller examines the Person Complex strategy and iterates over the output properties (e.g., name, DOB, address, income, position, employer). The Abstract Marshaller finds the “name” property.

The Abstract Marshaller invokes the Strategy (Java method invoked via reflection) and calls the production of PersonImpl.getName( ) to gets the value for “name”. Because the value is a simple data type (string), the Abstract Marshaller calls a grammar method such as startProperty (“name”) outputSimpleValue (string) endProperty.

The JSON marshaller implements this grammar method from the Abstract Marshaller. On startProperty, it outputs the syntax to start a property in JSON (e.g., “name”), then outputs a quoted string value in a JSON-specific way. This output is passed to the output stream (e.g., HTTP response) via an output stream in the Marshalling Request.

The Abstract Marshaller looks at the next property (e.g., nextproperty) and calls other grammar methods that allow the marshallers to do clean-up/syntax as needed on the output properties and continues.

Eventually, the Abstract Marshaller gets to the “employer” property and sees that the result is a complex data type. The Abstract Marshaller calls a grammar method (e.g., startComplexProperty). The Abstract Marshaller calls the Core Strategy Provider. In this case, for Employer, the Core Strategy Provider has no explicit strategy, so it falls back on Bean Strategy Provider which maps the properties of the object. It should be noted that “employer” is produced by a method not on PersonImpl, but on a strategy for example via some database access method. The Abstract Marshaller recurses down the object graph until it cannot resolve a complex type (error) or has marshalled all data.

In sum, there is an interaction between the Abstract Marshaller and the Strategy Provider (the combination of which is the intermediary) to define output content and format for a marshalled object. The Strategy Provider uses the at least one Strategy and its specific logic to decide how to produce an output property for the object. The Abstract Marshaller is the engine that does the basic recursion of the output property in a generic way and defines the grammar handlers that the selected Marshaller implements concretely.

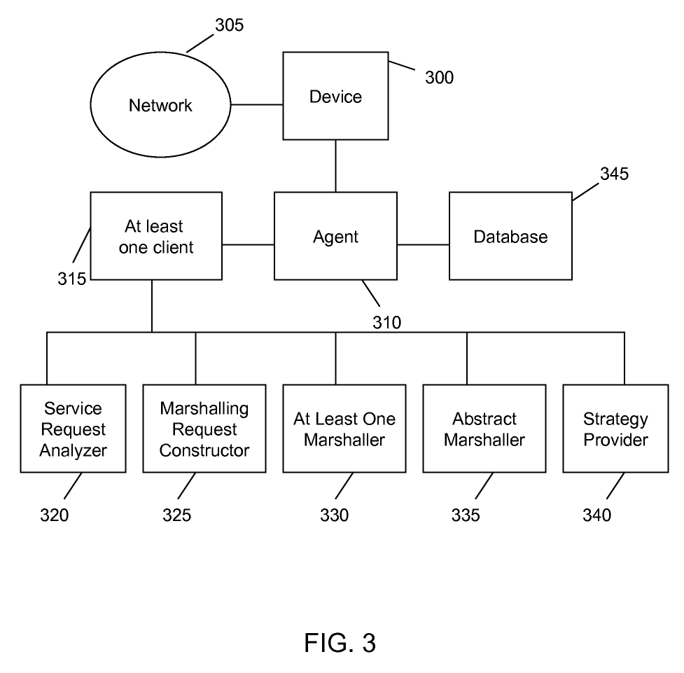

FIG. 3 illustrates is a block diagram of a system according to an embodiment of the present invention. The illustrative system includes at least one electronic or digital device 300 (e.g., a personal computer, cellular telephone, personal digital assistant or PDA, game device, MP3 player, television). The device may be connected to a network 305 (e.g., the Internet, local area network (LAN), wide area network (WAN)). In embodiments of the invention, the system includes at least one agent 310 for generic marshalling of an object and includes at least one client 315 for data processing of the at least one object. The illustrative system is but one example, and one of ordinary skill in the art would recognize that many other variations may exist, all of which are contemplated by the invention.

The at least one client 315 comprises a service request analyzer 320 to analyze a service request for an object; marshalling request constructor 325 to construct at least one marshalling request from data in the service request; at least one marshaller 330 to provide output in a specific format; an abstract marshaller 335 to provide generic resolution support for the at least one marshaller; and a strategy provider 340 to produce or call at least one strategy. The system also comprises a database 345 for housing the at least on strategy. In embodiments, the agent and its at least one client may be applications residing on at least one of the electronic or digital devices or may be stand-alone applications.

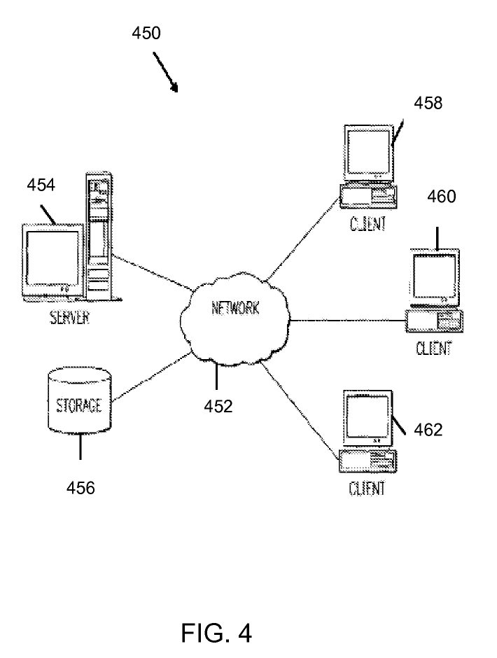

FIG. 4 illustrates an exemplary embodiment of a network data processing system in which the present invention may be implemented. Network data processing system 450 is a network of computers in which the present invention may be implemented. Network data processing system contains a network 452, which is the medium used to provide communications links between various devices and computers connected together within the network data processing system. Network may include connections, such as wire, wireless communication links, or fiber optic cables.

In the illustrated example, a server 454 is connected to network 452 along with storage unit or medium 456. In addition, clients 458, 460, and 462 also are connected to network 452. Network 452 may include permanent connections, such as wire or fiber optic cables, or temporary connections made through telephone connections. The communications network also can include other public and/or private wide area networks, local area networks, wireless networks, data communication networks or connections, intranets, routers, satellite links, microwave links, cellular or telephone networks, radio links, fiber optic transmission lines, ISDN lines, T1 lines, DSL, etc. In some embodiments, a user device may be connected directly to a server 454 without departing from the scope of the present invention.

Clients 458, 460, and 462 may be, for example, personal computers, portable computers, mobile or fixed user stations, workstations, network terminals or servers, cellular telephones, kiosks, dumb terminals, personal digital assistants, two-way pagers, smart phones, information appliances, or network computers. For purposes of this application, a network computer is any computer, coupled to a network, which receives a program or other application from another computer coupled to the network.

In the illustrated example, server 454 provides data to clients 458-462. Clients 458, 460, and 462 are clients to server 454. Network data processing system may include additional servers, clients, and other devices not shown. In the depicted example, network data processing system might be the Internet with network representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system also may be implemented as a number of different types of networks, such as for example, an intranet, a local area network (LAN), or a wide area network (WAN). FIG. 15 is intended as an example, and not as an architectural limitation for the present invention.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The exemplary and alternative embodiments described above may be combined in a variety of ways with each other. Furthermore, the steps and number of the various steps illustrated in the figures may be adjusted from that shown.

Although the present invention has been described in terms of particular exemplary and alternative embodiments, it is not limited to those embodiments. Alternative embodiments, examples, and modifications which would still be encompassed by the invention may be made by those skilled in the art, particularly in light of the foregoing teachings.

1. A method for generic marshalling without object modification, comprising:
making a service request for at least one object by inputting data into a computer system;
constructing at least one marshalling request from the service request to marshal the at least one object;
selecting a marshaller that supports an output format for data requested by the at least one marshalling request;
an abstract marshaller calling at least one strategy provider based on the at least one marshalling request and the selected marshaller; and
said at least one strategy provider calling at least one strategy,
wherein the at least one strategy defines a translation that converts values from the at least one object into a generic format recognized by the abstract marshaller so the values are translated into the specific output format supported by the selected marshaller.

2. A method according to claim 1, comprising:
said abstract marshaller invoking the at least on strategy and obtaining values from the at least one object for simple data;
said abstract marshaller calling a grammar method to request the obtained values be output in a generic format that can be read by the selected marshaller; and
said selected marshaller implementing the grammar method and outputting the obtained values in the output format.

3. A method according to claim 1, wherein if the data requested in the at least one marshalling request is complex, the abstract marshaller recurses the complex data and calls the at least one strategy provider.

4. A method according to claim 1, wherein the at least one object comprises data in the form of a collection of at least one of values, properties, or methods stored in memory.

5. A method according to claim 1, wherein a user a makes service request by inputting data via a web service.

6. A method according to claim 1, wherein data in the service request comprises at least one of an object name, output format for the at least one object, or scope of the at least one object.

7. A method according to claim 1, wherein the marshaller comprises a JSON marshaller or an XML marshaller.

8. A method according to claim 1, wherein the marshaller is selected from two or more marshallers dynamically plugged into the system without changing an underlying application.

9. A method according to claim 1, wherein the abstract marshaller calls the at least one strategy provider when non-defined data is encountered in the at least one marshalling request.

10. A method according to claim 9, wherein the abstract marshaller defines simple data comprising at least one of a string, number, or property.

11. A method according to claim 9, wherein the abstract marshaller defines complex data comprising a collection of properties.

12. A method according to claim 9, wherein the at least one strategy is specified for data that are not defined in the abstract marshaller.

13. A method according to claim 1, wherein the strategy used to marshal the at least one object changes based on the scope of the data in the service request.

14. A method according to claim 1, wherein the at least one marshalling request comprises a static data-to-strategy mapping used by the strategy provider to look up a particular strategy.

15. The method according to claim 1, wherein the at least one marshalling request comprises a data-to-strategy mapping that is dynamically built based on a rule set.

16. The method according to claim 1, wherein the at least one strategy comprises multiple strategies for a single object.

17. The method according to claim 1, wherein the at least one strategy comprises a plurality of strategies arranged in a hierarchical manner.

18. The method according to claim 1, wherein the at least one strategy is built at runtime via introspection.

19. The method according to claim 18, wherein the at least one strategy is built by extending data automatically by making a data source query.

20. The method according to claim 1, wherein the at least one object comprises a list or graph of objects.

21. The method according to claim 20, wherein the abstract marshaller iterates through the list or graph of objects.

22. A method for generic marshalling without object modification, comprising:
making a service request for at least one object by inputting data into a computer system;
constructing at least one marshalling request from the service request to marshal the at least one object;
selecting a marshaller that supports an output format for the data;
an abstract marshaller calling at least one strategy provider when non-defined data is encountered in the at least one marshalling request;
said at least one strategy provider calling at least one strategy;
if the data requested in the at least one marshalling request is simple, said abstract marshaller invoking the at least on strategy to obtain values for the data from the at least one object;
if the data requested in the at least one marshalling request is complex, the abstract marshaller recursing the complex data and calling the at least one strategy provider;
said abstract marshaller calling a grammar method to request the obtained values be in a generic format that can be read by the selected marshaller; and
said at least one marshaller implementing the grammar method and outputting the obtained values in the output format.

23. An apparatus for generic marshalling without object modification, comprising:
an agent for generic marshalling of an object; and
at least one client for processing of data from the at least one object, said at least one client comprising an abstract marshaller to provide generic resolution support for at least one marshaller and a strategy provider to produce or call at least one strategy.

24. An apparatus according to claim 23, wherein said at least one client comprises:
a service request analyzer to analyze a service request for an object;
marshalling request constructor to construct at least one marshalling request from data in the service request; and
at least one marshaller to provide output from the at least one object in a specific format.

25. A computer program product, comprising
a computer useable medium having a computer readable program, wherein the computer readable program when executed on a computer causes the computer to:
make a service request for at least one object by inputting data into a computer system;
construct at least one marshalling request from the service request to marshal the at least one object;
select a marshaller that supports an output format for data from the at least one object;
an abstract marshaller calls at least one strategy provider based on the at least one marshalling request and the selected marshaller; and
said at least one strategy provider calls at least one strategy,
wherein the at least one strategy defines a translation that converts data from the at least one object into a generic format recognized by the abstract marshaller so it can be converted in to the specific output format supported by the selected marshaller.
